(19) United States
(12) Patent Application Publication
(10) Pub. No.: US 2014/0133927 A1
(43) Pub. Date: May 15, 2014

(54) LAWN SPRINKLER TRIMMER WITH STABILIZERS

(71) Applicant: LOUIE BORT, West Richland, WA (US)

(72) Inventor: LOUIE BORT, West Richland, WA (US)

(21) Appl. No.: 13/673,671

(22) Filed: Nov. 9, 2012

(51) Int. Cl. A01D 34/84; A01D 34/82

(52) U.S. Cl. CPC A01D 34/84; A01D 34/82
USPC 408/112; 408/110

(57) ABSTRACT

A Lawn Sprinkler Trimmer with Stabilizers or Levelers having a plurality of alignment frame members interconnected by alignment rods. A hole saw shaft rotatably extends through the plurality of alignment frame members and connects rigidly to a hole saw. The structure allowing leveling and stability in positioning the hole saw proximal a lawn sprinkler allowing grass trimming.

### FIELD OF THE INVENTION

This invention relates in general to trimming landscape growth and in particular to trimming the area around lawn sprinkler heads.

### BACKGROUND OF THE INVENTION

Lawn and landscape trimming devices, including those to trim around sprinkler heads are knows including Pat. App. 2010/0230123 to Ortiz noting the abstract and FIG. 1; U.S. Pat. No. 4,260,026 to Deckert, Apr. 2, 1981 noting FIG. 1; U.S. Pat. No. 4,357,752 to Goodwin Jr., Nov. 9, 1982 noting the Abstract and FIG. 5 and Column 2; lines 30-50; U.S. Pat. No. 4,479,302 to Richter, Oct. 30, 1984 noting FIGS. 1, 2, 3 and 4 and Column 2; lines 32-49; U.S. Pat. No. 4,547,966 to Eden, Oct. 22, 1985 noting FIGS. 1 and 2; U.S. Pat. No. 5,461,788 to Taylor, Oct. 31, 1995 noting the Abstract and FIG. 1 through 5; U.S. Pat. No. 6,134,789 to Strickland, Oct. 24, 2000 noting the Abstract, FIG. 2 and FIG. 3; U.S. Pat. No. 6,311,782 to Plasek et al, Nov. 6, 2001 noting FIG. 1; U.S. Pat. No. 7,774,950 to Lasey, Aug. 17, 2010 noting the Abstract and FIG. 1 through 3; U.S. Pat. No. 8,109,006 to Knudsen noting the Abstract and FIG. 1; Pat. App. No. 20090255696 to Ortiz noting the Abstract and FIGS. 1, 3 and 4.

The patents and publications referred to herein are provided herewith in an Information Disclosure Statement in accordance with 37 CFR 1.97.

### SUMMARY OF THE INVENTION

The present invention comprises an alignment frame which stabilizes a sprinkler head grass trimmer for accurate trimming

### BRIEF DESCRIPTION OF THE FIGURES

The foregoing and other features and advantages of the present invention will become more readily appreciated as the same become better understood by reference to the following detailed description of the preferred embodiment of the invention when taken in conjunction with the accompanying drawings, wherein:

FIGS. 1 and 2 show the structural elements with FIG. 1 illustrating in an exploded and FIG. 2 illustrating in an assembled view of the sprinkler trimmer or edger device (1) showing the alignment frame first plate (100), alignment frame intermediate plate (101), alignment frame hole saw guide plate (103), alignment rod apertures (102), alignment rods (105), hole saw shaft aperture (104), hole saw shaft (106), Shaft end cap (108), chuck (110), welds (112), alignment frame plate spacer (200), alignment rod springs (300), hole saw (220) and hole saw depth limiter (210).

FIG. 3 shows a section from FIG. 2 illustrating the interconnection of the alignment frame plate spacer (200) with the alignment frame intermediate plate (101) shown as a rectangular or square plate. Illustrated is the alignment frame plate spacer (200) as a segment of a cylinder with weld (112) interconnections. Welds (112), as used relative to this invention, includes metal welding and brackets, nuts and bolts, screws, rivets and other mechanical devices when the when the structure is metal and glues, epoxies or other chemical interconnection methods when the structure is comprised of plastics or carbon composite materials.

FIG. 4 shows the alignment frame plate spacer (200) as upright extending plates with weld (112) interconnection to the alignment frame intermediate plate (101) which is shown in an alternative circular planar plate form.

### DETAILED DESCRIPTION OF THE INVENTION

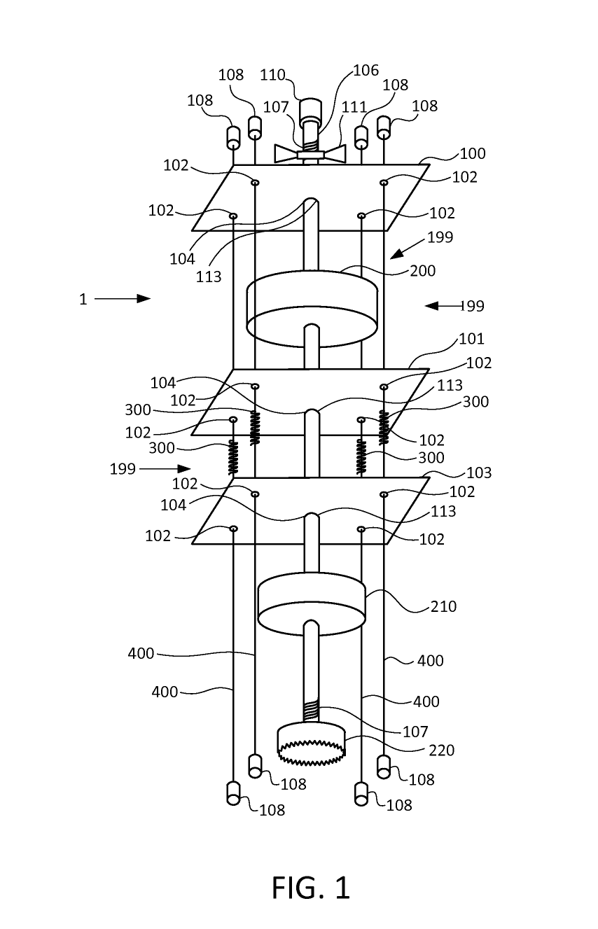

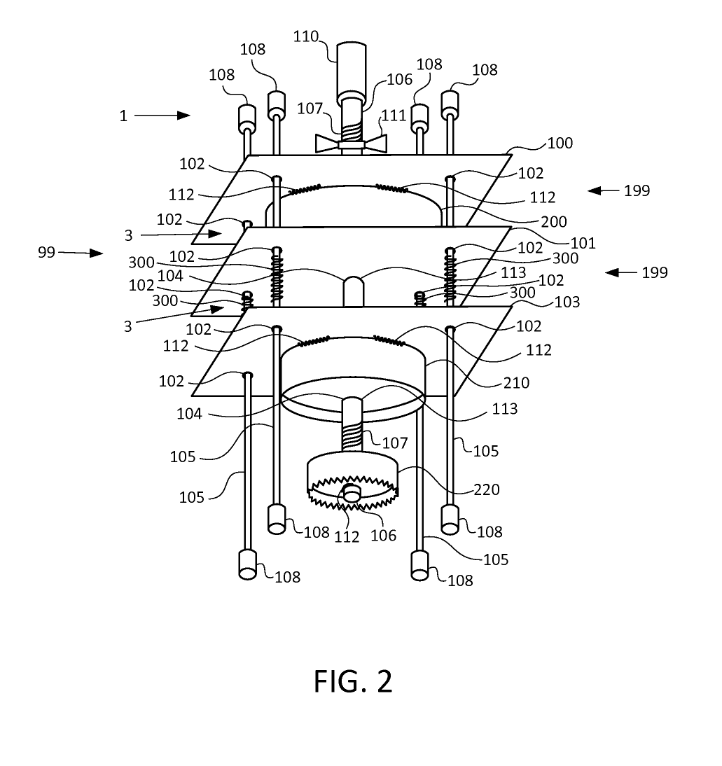

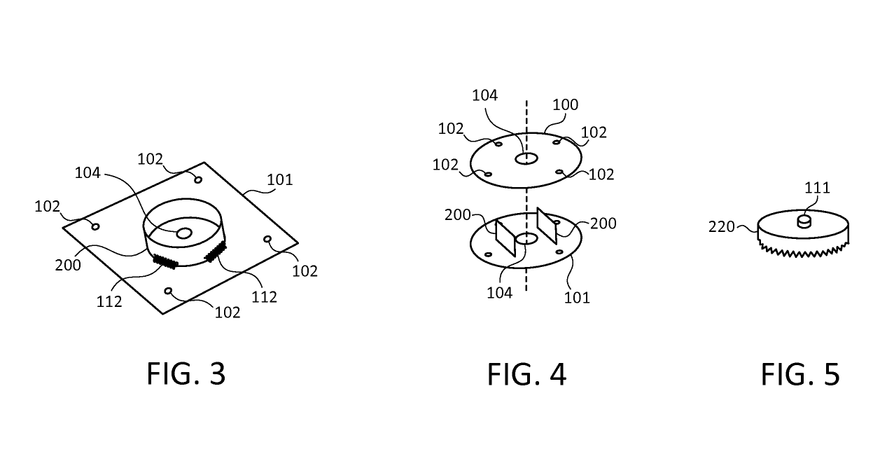

The preferred embodiment of the apparatus of this disclosure is seen in FIG. 1 through FIG. 4 illustrating the Lawn Sprinkler Trimmer (1) comprising a plurality of alignment frame members (99) where the said alignment frame members (99) are planar and comprised of rigid plastics, nylon, carbon composites and or metals. The said plurality of alignment frame members (99) are further comprised, in the preferred embodiment, of an alignment frame intermediate plate (101) which is intermediate an alignment frame first 4 plate (100) and an alignment frame hole saw guide plate (103). The alignment frame members (99) are planar and are generally rectangular in the preferred embodiment. However, a person of ordinary skill in the mechanical arts will recognize that many other shapes will be of utility including circular and oval and others.

Each of the said alignment frame intermediate plate (101), alignment frame first plate (100) and alignment frame hole saw guide plate (103) have a plurality of alignment rod apertures (102) with each of the said alignment rod apertures (102) being in vertical alignment with at least one alignment rod apertures (102) in each of the said alignment frame intermediate plate (101), alignment frame first plate (100) and alignment frame hole saw guide plate (103).

A plurality of alignment rods (105) interconnect the said intermediate plate (101), alignment frame first plate (100) and alignment frame hole saw guide plate (103) wherein each of the alignment rods (105) is in vertical alignment with and inserted into at least one alignment rod aperture (102) in each of the said alignment frame intermediate plate (101), alignment frame first plate (100) and alignment frame hole saw guide plate (103); and the said intermediate plate (101) and alignment frame first plate (100) are parallel and are separated by at least one rigid spacer; the at least one or a plurality of alignment frame plate spacers (200) are immovably affixed to the said intermediate plate (101) and are 24 upstanding toward and in contact with and immovably affixed to the said alignment frame first plate (100); affixing the spacer is with glues, epoxies or other adhesives or chemical processes where the alignment frame members are comprised of plastics or carbon composites; affixing the spacer is generally with welding where the alignment frame members are comprised of metal; affixing the spacer may also be with other mechanical including brackets, nuts and bolts, screws, rivets and other mechanical devices when the alignment frame members (99) are composed of metal. Testing demonstrates that where the plurality of alignment frame members (99) are approximately 7″×7″, that a circular alignment frame plate spacers (200) of approximately 6.5″ in diameter and 4″ in height provides stability in the use and operation of the invention. A range height of 1″ to 4″ is preferred.

A plurality of elongated alignment rods (105) interconnect the said intermediate plate (101), alignment frame first plate (100) and alignment frame hole saw guide plate (103). Each of the alignment rods (105) is in vertical alignment with and movably inserted, for generally vertical movement, into at least one alignment rod aperture (102) in each of the said alignment frame intermediate plate (101), alignment frame first plate (100) and alignment frame hole saw guide plate (103). At least three elongated alignment rods (105) are expected to be found in the structure to assure stability and alignment of the invention when in use. However, the preferred embodiment, as seen in FIGS. 1 and 2, will use at least four alignment rods (105). The alignment rods (105) are rigid, generally circular in cross section, and made of metal.

The said intermediate plate (101) and alignment frame first plate (100) are parallel and are separated by at least one rigid spacer; the at least one or a plurality of alignment frame plate spacers (200) are immovably affixed to the said intermediate plate (101) and are upstanding toward and in contact with and immovably affixed to the said alignment frame first plate (100); affixing the spacer is with glues, epoxies or other adhesives or processes where the alignment frame members are comprised of plastics or carbon composites; affixing the spacer is generally with welding where the alignment frame members are comprised of welding. However, a person of ordinary skills in mechanical arts will recognize that other mechanical methods may be used including brackets, nuts and bolts, screws, rivets and other mechanical devices.

A hole saw shaft aperture (104) is centrally disposed in each of the said intermediate plate (101), alignment frame first plate (100) and alignment frame hole saw guide plate (103). Each of the said hole saw shaft apertures (104) are in alignment and an elongated rigid tubular hole saw shaft (106) is rotatably extended through each of the hole saw shaft apertures (104). A hole saw (220), generally formed from metal, is beneath the alignment frame hole saw guide plate (103). The said hole saw shaft (106) is immovably affixed to the hole saw (220) generally by metal welding. A chuck fixture (110) is affixed to the hole saw shaft (106) most distal to the hole saw (220). The chuck fixture (110) shaped or formed for secure fitting with a drill motor chuck or another motor fixture.

A hole saw depth limiter (210) is intermediate the alignment frame hole saw guide plate (103) and the hole saw (220). The hole saw depth limiter (210) is generally circular or semi circular and concentric with and encompasses the hole saw (220) and is rigidly affixed to the alignment frame hole saw guide plate (103) by weld (112). There is at least one alignment rod spring (300) which encompasses each alignment rod (105) between the alignment frame intermediate plate (101) and alignment frame hole saw guide plate (103) urging by a spring function the said alignment frame intermediate plate (101) and alignment frame hole saw guide plate (103) apart while allowing, by a spring function, a leveling of the Lawn Sprinkler Trimmer (1) relative to the sprinkler head to be trimmed.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims.

I claim:

1. A Lawn Sprinkler Trimmer comprising the following:
a plurality of alignment frame members (99); the said alignment frame members (99) are planar and comprised of rigid plastics, nylon, carbon materials including carbon composites and or metals; the said alignment frame members (99) are further comprised of an alignment frame intermediate plate (101) which is intermediate an alignment frame first plate (100) and an alignment frame hole saw guide plate (103); and
each of the said the said alignment frame intermediate plate (101), alignment frame first plate (100) and alignment frame hole saw guide plate (103) have a plurality of alignment rod apertures (102); each of the said alignment rod apertures (102) is in vertical alignment with at least one alignment rod apertures (102) in each of the said alignment frame intermediate plate (101), alignment frame first plate (100) and alignment frame hole saw guide plate (103); and
a plurality of alignment rods (105) interconnect the said intermediate plate (101), alignment frame first plate (100) and alignment frame hole saw guide plate (103) wherein each of the alignment rods (105) is in vertical alignment with and inserted into at least one alignment rod aperture (102) in each of the said alignment frame intermediate plate (101), alignment frame first plate (100) and alignment frame hole saw guide plate (103); and
the said intermediate plate (101) and alignment frame first plate (100) are parallel and are separated by and rigidly affixed, by spacer affixing means, to at least one or a plurality of alignment frame plate spacers (200); the at least one or a plurality of alignment frame plate spacers (200) are affixed to the said intermediate plate (101) and are upstanding toward and in contact with and affixed to the said alignment frame first plate (100); the spacer affixing means comprising glues or epoxies or welding; and the said alignment frame plate spacer (200) is one or more upstanding planar plate or is an upstanding cylindrical segment; and
a hole saw shaft aperture (104) centrally disposed in each of the said intermediate plate (101), alignment frame first plate (100) and alignment frame hole saw guide plate (103); each of the said hole saw shaft apertures (104) are in alignment; an elongated tubular hole saw shaft (106) extending through each of the hole saw shaft apertures (104); the said hole saw shaft (106) threaded above the alignment frame first plate (100) and threaded below the alignment frame hole saw guide plate (103); the hole saw shaft (106) removably affixed by wingnut and thread above the alignment frame first plate (100) to allow removal of the said hole saw shaft (106) for repair; the hole saw shaft (106) removably affixed by nut and thread to a downwardly extending hole saw (220); a drill chuck fitting (110) at said hole saw shaft (106) most distal to the hole saw (220) and above the alignment frame first plate (100); and
the hole saw (220) downwardly extending from the alignment frame hole saw guide plate (103); a hole saw depth limiter (210) intermediate the alignment frame hole saw guide plate (103) and the hole saw (220); the hole saw depth limiter (210) is rigidly affixed to the alignment frame hole saw guide plate (103).

2. A Lawn Sprinkler Trimmer (1) comprising the following:
a plurality of alignment frame members (99); each of the said alignment frame members (99) are parallel with each other of the said alignment frame members (99) and each of said alignment frame members (99) have a plurality of alignment rod apertures (102) with each of the said alignment rod apertures (102) in vertical alignment with at least one alignment rod apertures (102) in each of the said plurality of alignment frame members (99); and
the said plurality of alignment frame members (99) are further comprised of at least an alignment frame intermediate plate (101) which is intermediate an alignment frame first plate (100) and an alignment frame hole saw guide plate (103); and
a plurality of alignment rods (105) interconnect the said plurality of frame members (99) wherein each of the plurality of alignment rods (105) is in vertical alignment with and inserted into one of the alignment rod apertures (102) in each of the plurality of alignment frame members (99); and
a hole saw shaft aperture (104) is centrally disposed in each of the said plurality of alignment frame members (99); each of the said hole saw shaft apertures (104) are in alignment; a hole saw (220) is outwardly and downwardly extending beneath the alignment frame hole saw guide plate (103); an elongated tubular hole saw shaft (106) rotatably extends through each of the hole saw shaft apertures (104); the said hole saw shaft (106) is rigidly affixed to the downwardly extending hole saw (220); the hole saw shaft (106) is rigidly affixed to the hole saw (220); a chuck fixture (110) is affixed to the hole saw shaft (106) most distal to the hole saw (220) and above the alignment frame first plate (100); the chuck fixture (110) is shaped or formed for secure fitting with a drill motor chuck or another motor fixture for rotary operation of the hole saw (220). the said hole saw shaft (106) is affixed by to a chuck (110) most distal to the hole saw (220); and
a hole saw depth limiter (210) intermediate the alignment frame hole saw guide plate (103) and the hole saw (220); the hole saw depth limiter (210) is rigidly affixed to the alignment frame hole saw guide plate (103); at least one alignment rod spring (300) encompasses each alignment rod (105) between the alignment frame intermediate plate (101) and alignment frame hole saw guide plate (103) urging by a spring function the said alignment frame intermediate plate (101) and alignment frame hole saw guide plate (103) apart while allowing, by a compression spring function, a leveling of the invention relative to the sprinkler head to be trimmed.

3. A Lawn Sprinkler Trimmer (1) depending from claim 2 and further comprising;
the said plurality of alignment frame members (99) are planar and comprised of rigid plastics, carbon materials including carbon composites and or metals; and
the alignment rods (105) are elongated, rigid, tubular and generally metal; each alignment rod (105) has a shaft end cap (108) above the alignment frame first plate (100) and below the frame hole saw guide plate (103); the plurality of alignment rods (105) extend in length lower than the hole saw (220) will rotate; the hole saw shaft (106) is threaded from proximal the frame first plate (100) to the position of the hole saw shaft (106) most distal to the hole saw (220) including the chuck fixture (110) and the hole saw shaft (106) is threaded proximal the hole saw (220) with said threads (107) receiving nut fixtures including nuts and wing nuts (111); and
the said intermediate plate (101) and alignment frame first plate (100) are separated by at least one or a plurality of alignment frame plate spacers (200); the at least one or a plurality of alignment frame plate spacers (200) are immovably affixed to the said intermediate plate (101) and are upstanding toward and in contact with and immovably affixed to the said alignment frame first plate (100); a bearing surface (113) at each hole saw shaft aperture (104); and
the hole saw shaft (106) is rigidly affixed to the hole saw (220); a chuck fixture (110) is affixed to or formed at the hole saw shaft (200) most distal to the hole saw (220) and above the alignment frame first plate (100); the chuck fixture (110) is shaped or formed for secure fitting with a drill motor chuck or another motor fixture for rotary operation of the hole saw (220); and
the hole saw depth limiter (210) is generally circular or semi circular and concentric with and encompasses the hole saw (220).

4. A Lawn Sprinkler Trimmer (1) depending from claim 3 and further comprising:
affixing the frame plate spacers (200) is with glues, epoxies or other adhesives or chemical processes where the alignment frame members are comprised of plastics or carbon composites and with welding, nuts/bolts, screws, rivets, brackets or other mechanical devices where composed of metals; and
affixing the hole saw shaft (220) to the hole saw (200), where the hole saw (200) is removably affixed to the hole saw shaft (220) is with nuts/bolts, screws, or other mechanical devices which allow removal and, where the hole saw (200) immovably affixed to the hole saw shaft (220) is with glues, epoxies or other adhesives or chemical processes where the alignment frame members are comprised of plastics or carbon composites and with welding, nuts/bolts, screws, rivets, brackets or other mechanical devices where composed of metals; and
the said shaft end cap (108) is comprised of a removable cap which constrains the alignment rods (105) from being withdrawn from the said alignment rod apertures (102).

5. A Lawn Sprinkler Trimmer (1) depending from claim 4 and further comprising:
the said alignment frame plate spacer (200) is comprised of a segment of a cylinder; and
the said hole saw shaft (106) is rigidly and removably affixed to the hole saw (220) by threads (107) at the hole saw (220).

6. A Lawn Sprinkler Trimmer (1) depending from claim 4 and further comprising:
the alignment frame plate spacer (200) is comprised of at least one or a plurality of upright extending plates; and
the said hole saw shaft (106) is rigidly and immovably affixed to the hole saw (220) by welds (112).
